(19) United States
(12) Patent Application Publication
(10) Pub. No.: US 2016/0002958 A1
(43) Pub. Date: Jan. 7, 2016

(54) WATER-DUST-PROOF CASE FOR LOCK

(71) Applicant: FEDERAL LOCK CO., LTD., Pingtung County 912 (TW)

(72) Inventor: TIEN-KAO LIU, PINGTUNG COUNTY 912 (TW)

(21) Appl. No.: 14/324,454

(22) Filed: Jul. 7, 2014

(51) Int. Cl. E05B 67/02; E05B 67/38

(52) U.S. Cl. CPC E05B 67/02; E05B 67/38

(57) ABSTRACT

A water-dust-proof case for a lock includes a case with a bottom plate connected to the bottom thereof. The bottom plate has a through hole and a guide slot. The case having a slide slot which is located corresponding to the through hole and the guide slot. A slide is connected to the bottom plate and has a covering portion which is used to cover the through hole and the guide slot. The covering portion has an extension portion which is located corresponding to the guide slot. The extension portion has a neck which is slidable relative to the guide slot so as to move the covering portion to cover the through hole such that water and dust are prevented from entering the lock to case the core stocked.

### BACKGROUND OF THE INVENTION

1. Fields of the Invention

The present invention relates to a case for a lock, and more particularly, to a water-dust-proof case for a lock so as to prevent dust and water from entering the lock.

2. Descriptions of Related Art

There are different types of locks such as pad locks and combination locks. Most of the locks have a core with a keyhole, and multiple bead units are located in the core. The bead units each have slots arranged parallel to each other, and multiple beads are received in the slots. When a key is inserted into the keyhole, the beads are moved so that the core is rotatable to unlock the lock. In order to provide safety features, some locks have resilient members and dual-bead assemblies.

However, all of the conventional locks are exposed in the air so that dust and water can enter into the locks, and most of the locks are made by metal which gets rust due to moisture and the core may be stocked because of the rust. Furthermore, the dust may be attached to the beads along with the moisture and can make the beads be stocked and unable to move.

The door locks, the car locks and the pad locks are used outdoor so that these types of locks are more likely to be stocked or rusted. If the locks are used for a period of time, they may not be functioned properly and have to be replaced. This causes extra expenses for the users.

The present invention intends to provide a water-dust-proof case for a lock and eliminates the shortcomings mentioned above.

### SUMMARY OF THE INVENTION

The present invention relates to a water-dust-proof case for a lock, and comprises a case having a bottom plate connected to the bottom thereof. The bottom plate has a through hole, and a guide slot extends from the inner periphery of the through hole. The case has a slide slot which is located corresponding to the through hole and the guide slot. A slide is connected to the bottom plate and has a covering portion which is used to cover the through hole and the guide slot. The covering portion has an extension portion extending therefrom and the extension portion is located corresponding to the guide slot. The extension portion has a neck connected thereto which is slidable relative to the guide slot so as to move the covering portion to cover the through hole.

Preferably, the slide slot has at least one engaging portion defined in a sidewall thereof. The neck has at least one resilient portion which has an engaging member and the engaging member is engaged with the at least one engaging portion.

Preferably, there are multiple engaging portions defined in the sidewall thereof. The engaging portion are located at positions where the covering portion covers the through hole, and positions where the covering portion does not cover the through hole.

Preferably, the engaging portion are located along two opposite insides of the sidewall of the slide slot.

Preferably, the at least one resilient member is formed with the neck and a gap is formed between the at least one resilient member and the neck.

Preferably, two stops are respectively formed on two ends of the guide slot. The two stops are respectively located at positions where the covering portion covers the through hole, and positions where the covering portion does not cover the through hole.

Preferably, the case has at least one connection portion formed in a wall thereof. The bottom plate has at least one connector which is engaged with the at least one connection portion.

Preferably, the at least one connection portion is a recess and the at least one connector is a protrusion.

Preferably, the at least one connector has an inclined face and a stepped portion is formed beneath the inclined face. The stepped portion is engaged with the at least one connection portion.

Preferably, the case accommodates a lock which has a keyhole. The keyhole is located corresponding to the through hole.

Preferably, the lock 4 is a pad lock.

Preferably, the case has two apertures located in the top thereof. The lock has a shackle which extends through the two apertures.

The primary object of the present invention is to provide a water-dust-proof case for a lock such that dust and water cannot enter the lock.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the water-dust-proof case of the present invention;

FIG. 2 is an exploded view of the water-dust-proof case of the present invention;

FIG. 3 shows that a lock is received in the water-dust-proof case of the present invention;

FIG. 4 is an exploded view of the water-dust-proof case of the present invention and the lock to be received in the case;

FIG. 5 shows the lock is a pad lock and the shackle extends through the two apertures of the water-dust-proof case of the present invention;

FIG. 6 is a partial cross sectional view to show the slide movable along the bottom plate of the water-dust-proof case of the present invention;

FIG. 7 is a cross sectional view, taken along line A-A of FIG. 3;

FIG. 8 is a cross sectional view, taken along line B-B of FIG. 3;

FIG. 9 is a bottom view to show that the through hole of the water-dust-proof case of the present invention is covered by the covering portion, and

FIG. 10 is a bottom view to show that the through hole of the water-dust-proof case of the present invention is exposed while the covering portion is moved aside.

### DETAILED DESCRIPTION OF THE PREFERRED EMBODIMENT

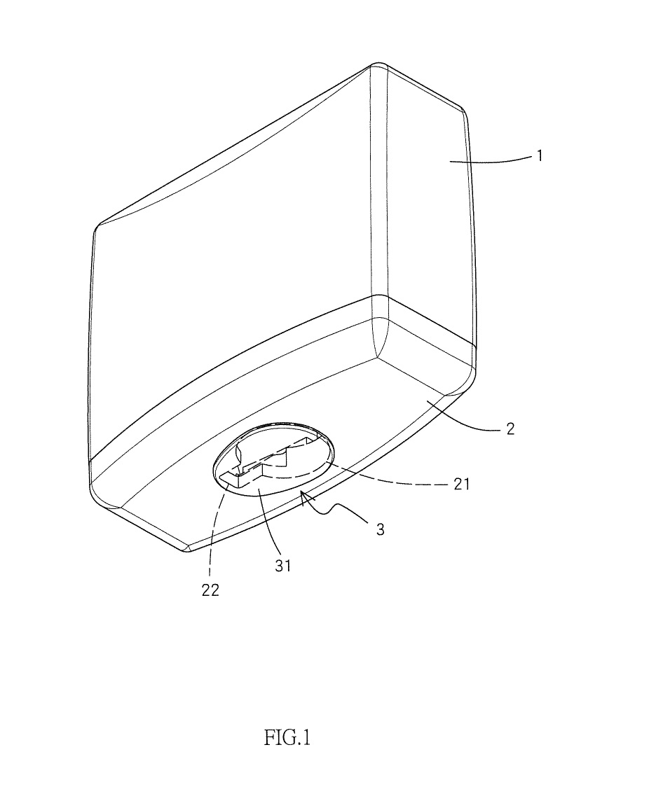

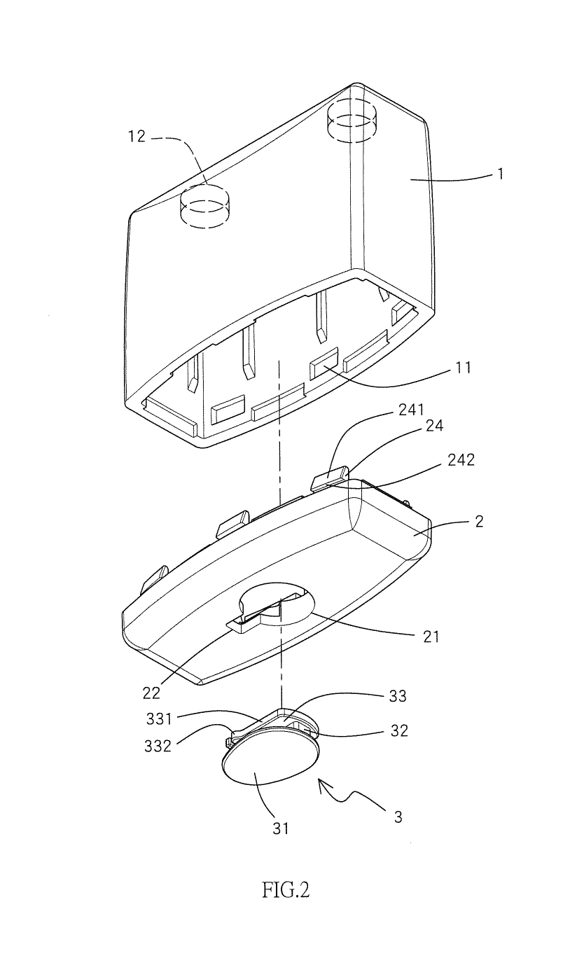

Referring to FIGS. 1 to 2, the water-dust-proof case of the present invention comprises a case 1 having a bottom plate 2 connected to the bottom thereof. The bottom plate 2 has a through hole 21, and a guide slot 22 is defined in the inner periphery of the through hole 21 and communicates with the through hole 21. The case 1 has at least one connection portion 11 formed in the wall thereof. The bottom plate 2 has at least one connector 24 which is engaged with the at least one connection portion 11. The at least one connection portion 11 is a recess and the at least one connector 24 is a protrusion. The at least one connector 24 has an inclined face 241 and a stepped portion 242 is formed beneath the inclined face 241. The stepped portion 242 is engaged with the at least one connection portion 11.

A slide 3 connected to the bottom plate 2 and has a covering portion 31 which is used to cover the through hole 21 and the guide slot 22. The covering portion 31 has an extension portion 32 extending therefrom and the extension portion 32 is located corresponding to the guide slot 22. The extension portion 32 has a neck 33 connected thereto which is slidable relative to the guide slot 22 so as to move the covering portion 32 to cover the through hole 21. The slide slot 23 has engaging portions 231, 231′ defined in two opposite insides of the sidewall thereof. The neck 33 has resilient portions 331 and each resilient portion 331 has an engaging member 32. The engaging members 32 are engaged with the engaging portions 231, 231′. The engaging portion 231, 231′ are located at positions where the covering portion 31 covers the through hole 21, and positions where the covering portion 31 does not cover the through hole 21. The resilient members 331 each are formed with the neck 33 and a gap 333 is formed between each of the resilient members 331 and the neck 33 so as to be flexible. Two stops 232, 232′ are respectively formed on two ends of the guide slot 22. The two stops 232, 232′ are respectively located at positions where the covering portion 31 covers the through hole 21, and positions where the covering portion 31 does not cover the through hole 21.

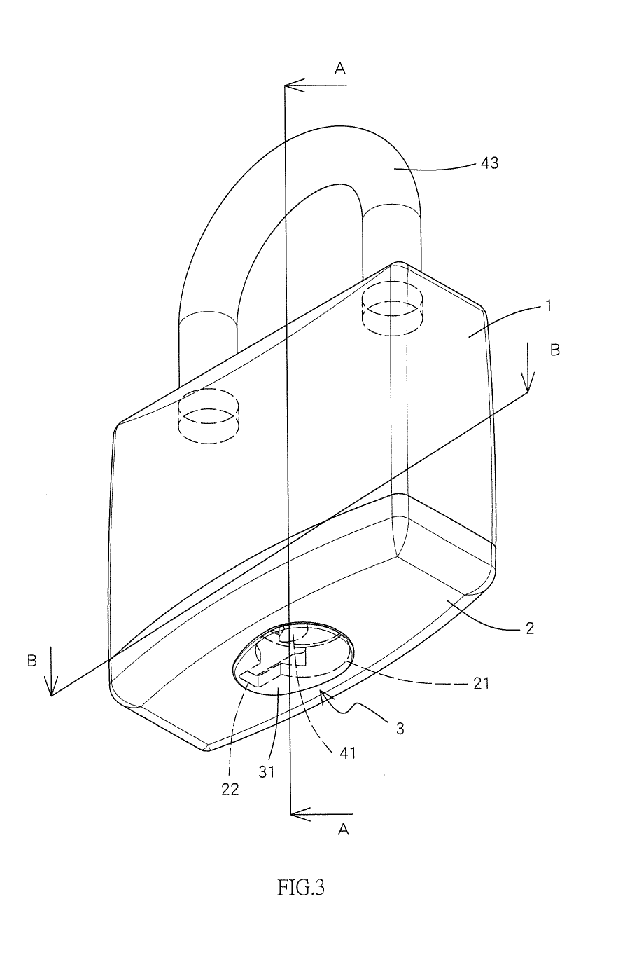

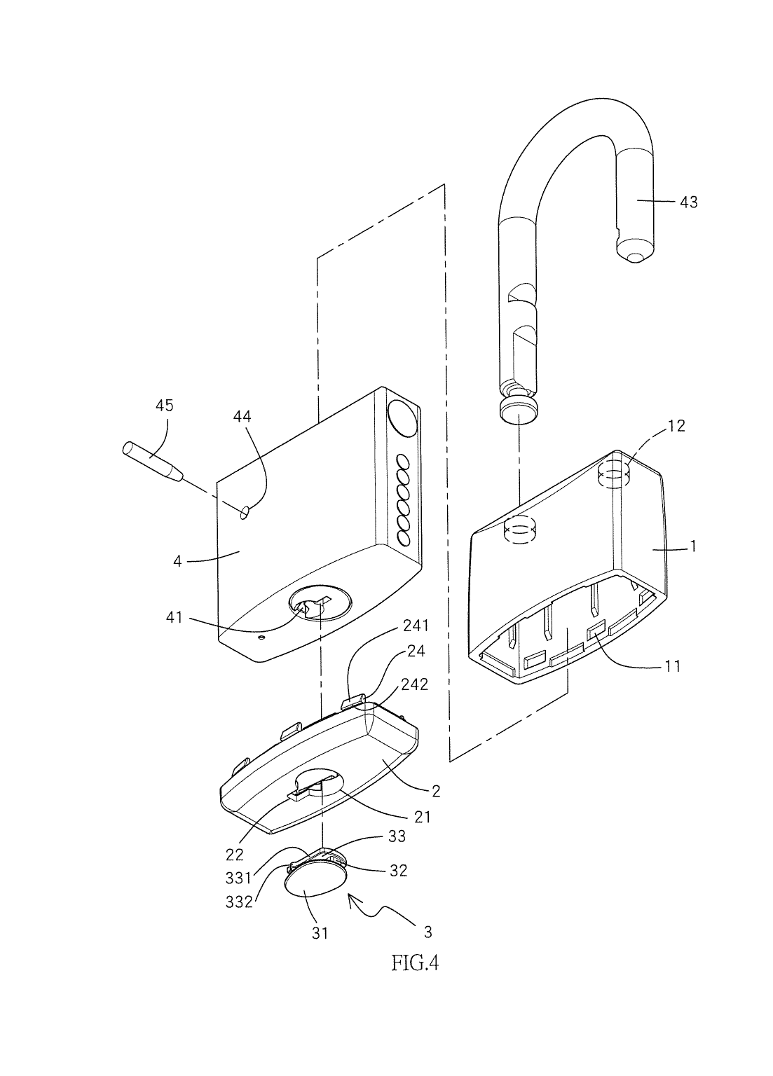

As shown in FIGS. 3 and 4, a lock 4 such as a pad lock is accommodated in the case 1. The lock 4 has a keyhole 41 which is located corresponding to the through hole 21. The case 1 has two apertures 12 located in the top thereof, the lock 4 has a shackle 43 which extends through the two apertures 12. The lock 4 has a path 42 and a passage 44 is defined in the lock 4 and communicates with the path 42. A pin 45 extends through the passage 44 to position the shackle 43.

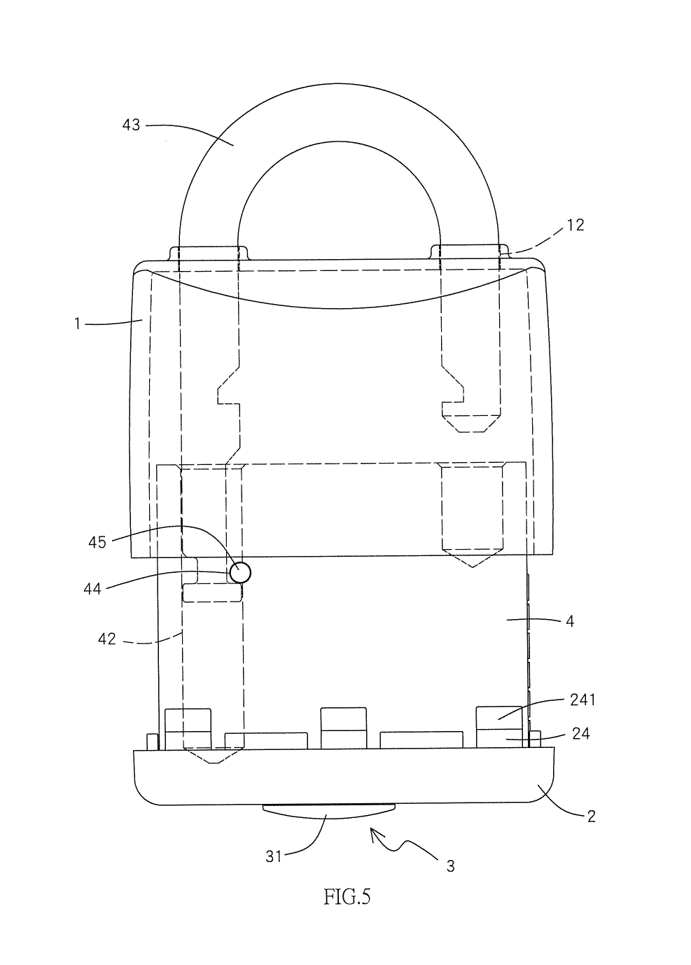

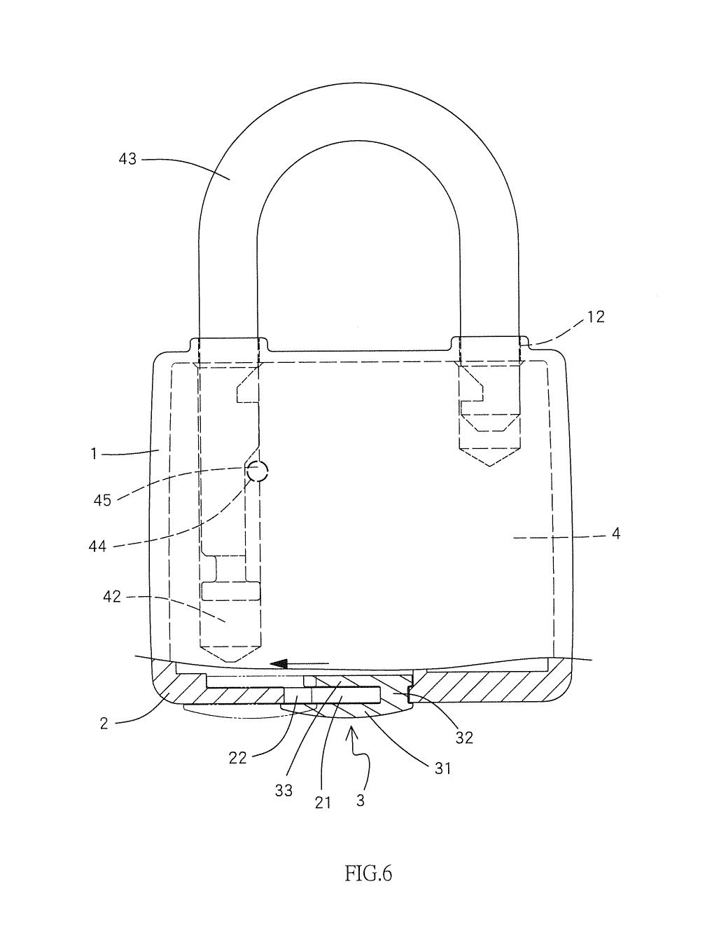

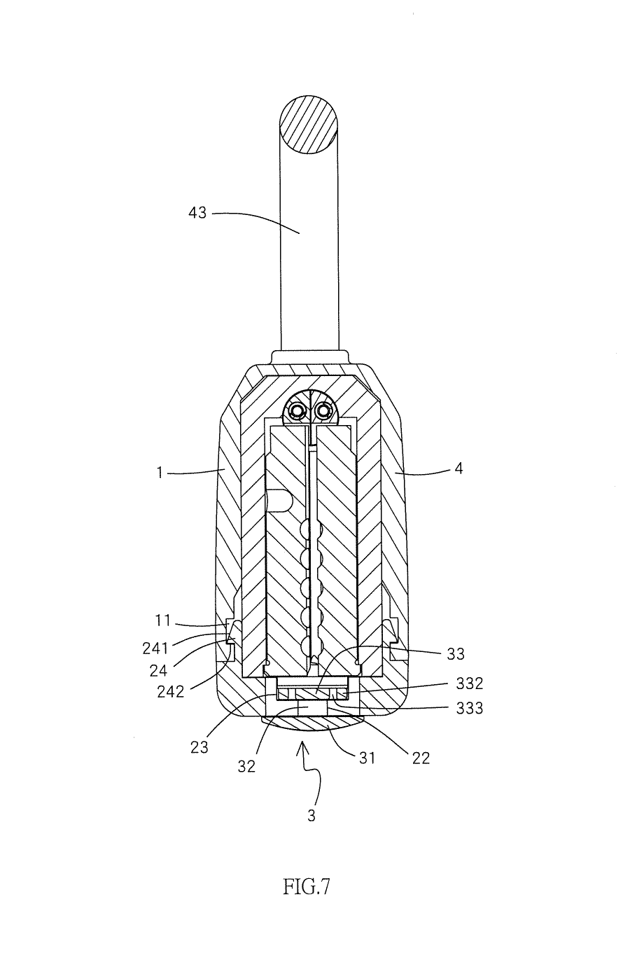

As shown in FIG. 5, the two ends of the shackle 43 are inserted into the two apertures 12 of the case 1 and the longer end of the shackle 43 is located in the path 42, and the passage 44 is exposed in the bottom of the case 1. The pin 45 extends through the passage 44 to position the shackle 43. The pin 45 contacts against the inside of the case 1 and does not drop from the lock 4. The slide 3 is connected to the bottom plate 2 as shown in FIG. 6, the extension portion 32 of the slide 3 is located at the guide slot 22 of the bottom plate 2. The neck 33 is located in the slide slot 23. The bottom plate 2 is connected to the underside of the case 1 and the lock 4 is accommodated in the case 1 as shown in FIG. 7. The stepped portions 242 of the connectors 24 are engaged with the connection portion 11 by the guidance of the inclined faces 241 to connect the bottom plate 2 to the case

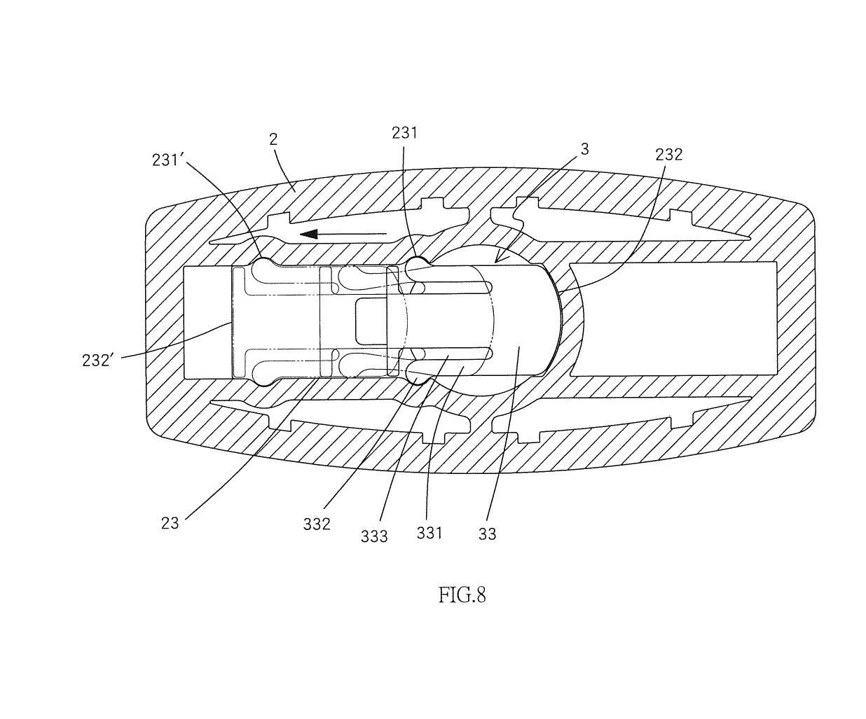

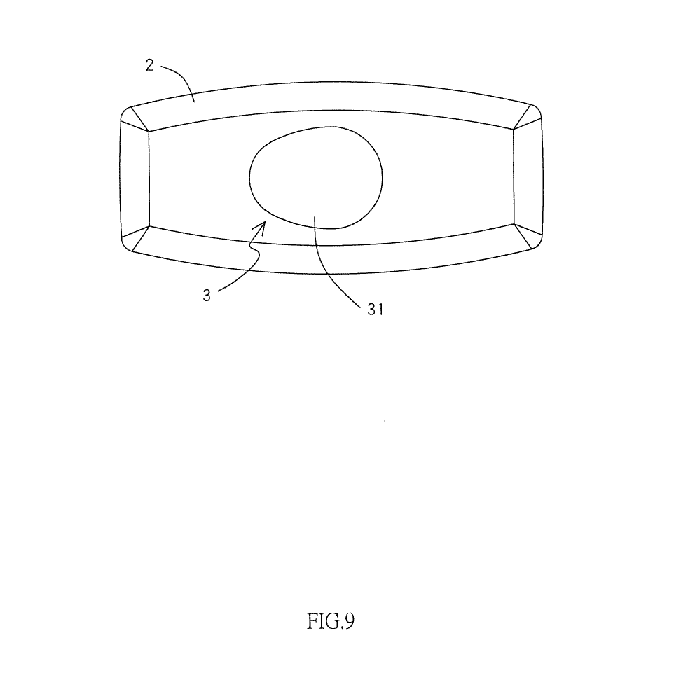

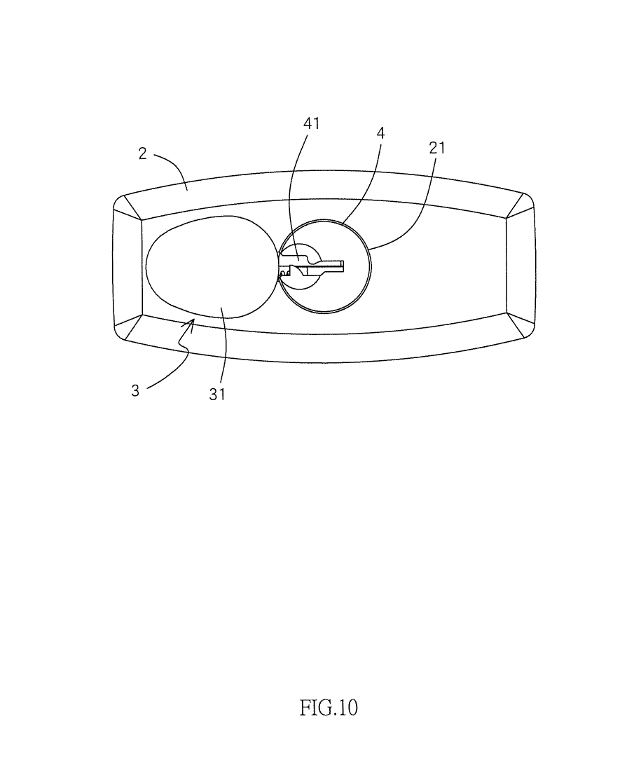

As shown in FIGS. 8 to 10, when neck 33 is movable in the slide slot 23, so that when the slide 3 is slid, the user pushes the covering portion 31 to move the neck 33. The resilient members 331 are pushes inward by the insides of the slide slot 23 so that the resilient members 331 are squeezed toward the neck 33 and the gaps 333 are narrowed, until the engaging members 332 are engaged with the engaging portions 231, 231′. By the resilient members 331, the slide 3 does not moved by its own weight or by a small force.

As shown in FIGS. 6, 8 and 9, by pushing the covering portion 31, the slide 3 moves toward the through hole 21 to let the covering portion 31 cover up the through hole 21 and the guide slot 22. Therefore, dust and water cannot enter the lock 4 via the keyhole 41. Because the stops 232, 232′ and the engaging portions 231, 231′ are located at the positions where the covering portion 31 covers the through hole 21, and the positions where the covering portion 31 does not cover the through hole 21, so that when the covering portion 31 covers up the through hole 21, the neck 33 is stopped by the stop 232, and the engaging members 332 are engaged with the engaging portions 231 so that the slide 3 is well positioned and the through hole 21 is not unintentionally explored.

On the contrary, as shown in FIGS. 6, 8 and 10, when the slide 3 is pushes toward the guide slot 22, the extension 32 does not interfere the slide 3 because of the guide slot 22. The neck 33 contacts the stop 232′ and the engaging members 332 are engaged with the engaging portions 231′ so that the through hole 21 and the keyhole 41 are explored. The user can insert the key into the keyhole 41 to unlock the lock 4. When the user unlocks the lock 4, the slide 3 is positioned by the engaging portions 231′ and does not slide back to affect the operation of the key.

While we have shown and described the embodiment in accordance with the present invention, it should be clear to those skilled in the art that further embodiments may be made without departing from the scope of the present invention.

What is claimed is:

1. A water-dust-proof case for a lock, comprising:
a case having a bottom plate connected to a bottom thereof, the bottom plate having a through hole, a guide slot extending from an inner periphery of the through hole, the case having a slide slot which is located corresponding to the through hole and the guide slot, and
a slide connected to the bottom plate and having a covering portion which is used to cover the through hole and the guide slot, the covering portion having an extension portion extending therefrom and the extension portion located corresponding to the guide slot, the extension portion having a neck connected thereto which is slidable relative to the guide slot so as to move the covering portion to cover the through hole.

2. The water-dust-proof case as claimed in claim 1, wherein the slide slot has at least one engaging portion defined in a sidewall thereof, the neck has at least one resilient portion which has an engaging member and the engaging member is engaged with the at least one engaging portion.

3. The water-dust-proof case as claimed in claim 2, wherein there are multiple engaging portions defined in the sidewall thereof, the engaging portion are located at positions where the covering portion covers the through hole, and positions where the covering portion does not cover the through hole.

4. The water-dust-proof case as claimed in claim 2, wherein the engaging portion are located along two opposite insides of the sidewall of the slide slot.

5. The water-dust-proof case as claimed in claim 2, wherein the at least one resilient member is formed with the neck and a gap is formed between the at least one resilient member and the neck.

6. The water-dust-proof case as claimed in claim 1, wherein two stops are respectively formed on two ends of the guide slot, the two stops are respectively located at positions where the covering portion covers the through hole, and positions where the covering portion does not cover the through hole.

7. The water-dust-proof case as claimed in claim 1, wherein the case 1 has at least one connection portion formed in a wall thereof, the bottom plate has at least one connector which is engaged with the at least one connection portion.

8. The water-dust-proof case as claimed in claim 7, wherein the at least one connection portion is a recess and the at least one connector is a protrusion.

9. The water-dust-proof case as claimed in claim 8, wherein the at least one connector has an inclined face and a stepped portion is formed beneath the inclined face, the stepped portion is engaged with the at least one connection portion.

10. The water-dust-proof case as claimed in claim 1, wherein the case 1 accommodates a lock which has a keyhole, the keyhole is located corresponding to the through hole.

11. The water-dust-proof case as claimed in claim 10, wherein the lock is a pad lock.

12. The water-dust-proof case as claimed in claim 11, wherein the case has two apertures located in a top thereof, the lock has a shackle which extends through the two apertures.
